(19) United States
(12) Patent Application Publication
(10) Pub. No.: US 2026/0318596 A1
(43) Pub. Date: Oct. 15, 2026

(54) Spray Freeze-Drying Device and Freeze-Drying Apparatus

(71) Applicant: TIANJIN ASYMCHE MMEDICAL SCIENCE AND TECHNOLOGY DEVELOPMENT CO., LTD., Binhai New Area, Tianjin (CN)

(72) Inventors: Hao Hong, Morrisville, NC (US); Liang Hong, Binhai New Area, Tianjin (CN); Jian Tao, Binhai New Area, Tianjin (CN); Hongru Zhou, Binhai New Area, Tianjin (CN); Bohui Wang, Binhai New Area, Tianjin (CN); Dan Liu, Binhai New Area, Tianjin (CN); Botao Liu, Binhai New Area, Tianjin (CN)

(21) Appl. No.: 19/474,968

(22) PCT Filed: Aug. 16, 2023
(86) PCT No.: PCT/CN2023/113395

§ 371 Date: Oct. 13, 2025

(30) Foreign Application Priority Data
Apr. 13, 2023 (CN) 202310393914.8

(51) Int. Cl. F26B 5/06; F26B 21/40

(52) U.S. Cl. CPC F26B 5/065; F26B 21/40

(57) ABSTRACT

A spray freeze-drying device and a freeze-drying apparatus are provided in the present disclosure. A freeze-drying component of the spray freeze-drying device includes a first body part having a first cavity and a second body part having a second cavity; when the first body part and the second body part are connected, the first cavity is in communication with the second cavity to jointly form a freezing cavity. The reagent nozzle penetrates through the first body part, such that the first nozzle port is in communication with the first cavity. While a liquid reagent is introduced into the first channel, a preset amount of nitrogen is introduced into the first channel, so that the liquid reagent entering the first channel is atomized into liquid droplet reagent under the action of nitrogen; when the liquid droplet reagent is sprayed into the freezing cavity through the first nozzle port, reagent ice droplets are formed and fall into the second cavity; by detaching the second body part from the first body part, the first connection port of the second body part is in communication with an air suction port of a vacuum unit. The spray freeze-drying device solves the problem in the related art of relatively low reagent preparation efficiency of a continuous vacuum drying apparatus.

This disclosure claims priority to Chinese Patent Application No. 2023103939148, filed to the China National Intellectual Property Administration on Apr. 13, 2023 and entitled “Spray Freeze-Drying Device and Freeze-Drying Apparatuses”.

### TECHNICAL FIELD

The present disclosure relates to the technical field of spray freeze-drying, and in particular, to a spray freeze-drying device and a freeze-drying apparatuses.

### BACKGROUND

Compared with traditional methods of drug delivery, drug delivery through the nose, epidermis, and lung inhalation of a patient shows certain advantages, which can allow a drug to act directly on a lesion, with rapid onset of action and definite therapeutic effect, and is the preferred approach especially for the current treatment of respiratory diseases.

An ideal inhalation preparation should have the following characteristics: low density, porosity, large specific surface area, relatively narrow aerodynamic particle size distribution, relatively low surface energy and potential, non-smooth spherical surface, relatively low density, and relatively high physical and chemical stability.

At present, a variety of different particle preparation technologies have been developed, among which a spray freeze-drying technology has the advantages of a relatively simple preparation process, applicability to high-value-added materials sensitive to high temperature, capability of avoiding physical instability caused by grinding, capability of generating small particles with a relatively narrow particle size distribution, no caking, good dispersibility, and the like.

The spray freeze-drying technology includes a continuous spray freeze-drying technology and a periodic vacuum drying technology. Compared with a periodic vacuum drying apparatus, a continuous vacuum drying apparatus has less auxiliary time, saves time, increases the yield, and does not need to change the temperature of the apparatus once for each production cycle like the periodic vacuum drying apparatus, resulting in part of the energy being wasted on repeated heating of apparatus components, thereby greatly saving the energy.

However, the existing continuous vacuum drying apparatus has the problem of relatively low reagent preparation efficiency.

A main objective of the present disclosure is to provide a spray freeze-drying device and a freeze-drying apparatus, so as to solve the problem in the related art of relatively low reagent preparation efficiency of a continuous vacuum drying apparatus.

In order to achieve the above objective, according to one aspect of the present disclosure, a spray freeze-drying device is provided, The spray freeze-drying device includes: a freeze-drying component, the freeze-drying component includes a first body part and a second body part, the first body part has a first cavity, and the second body part has a second cavity and a first connection port, the first connection port is in communication with the second cavity; wherein the first body part and the second body part are detachably connected; when the first body part and the second body part are connected, the first cavity is in communication with the second cavity to jointly form a freezing cavity, and the first cavity is located above the second cavity; and a reagent nozzle, the reagent nozzle has a first nozzle port, a reagent inlet, a nitrogen inlet and a first channel, the first nozzle port, the reagent inlet and the nitrogen inlet are all in communication with the first channel; wherein the reagent nozzle penetrates through the first body part, such that the first nozzle port is in communication with the first cavity; wherein while a liquid reagent is introduced into the first channel through the reagent inlet, a preset amount of nitrogen is introduced into the first channel through the nitrogen inlet, so that the liquid reagent entering the first channel is atomized into liquid droplet reagent under a pressure generated by the preset amount of nitrogen; when the liquid droplet reagent is sprayed into the freezing cavity through the first nozzle port, reagent ice droplets are formed and fall into the second cavity; and by detaching the second body part from the first body part, the first connection port of the second body part carrying the reagent ice droplets is configured to be in communication with an air suction port of a vacuum unit, to perform vacuum drying on the second cavity.

In some embodiments, an upper end of the second cavity is open, and a lower end of the first cavity is open; when the first body part is connected with the second body part, a lower end port of the first cavity is in communication with an upper end port of the second cavity in a docking manner; and the spray freeze-drying device further includes: a sealing cover, the sealing cover is configured to cover the upper end port of the second cavity after the second body part is detached from the first body part.

In some embodiments, the spray freeze-drying device further includes: a sieve plate, the sieve plate is disposed in the second cavity, and the sieve plate is spaced apart from a bottom wall of the second cavity, so that the reagent ice droplets entering the second cavity fall onto the sieve plate.

In some embodiments, the spray freeze-drying device further includes: a heat exchange component, the heat exchange component is disposed in the second cavity, and the heat exchange component is located between the sieve plate and the bottom wall of the second cavity; and a temperature control component, the temperature control component is connected with the heat exchange component to control a temperature of a heat exchange medium in the heat exchange component; wherein when the second body part is connected with the first body part, the heat exchange medium in the heat exchange component is a cooling medium.

In some embodiments, the spray freeze-drying device further includes: liquid nitrogen nozzle, the liquid nitrogen nozzle has a second nozzle port, a liquid nitrogen inlet and a second channel, the second nozzle port and the liquid nitrogen inlet are both in communication with the second channel; wherein the liquid nitrogen nozzle penetrates through the first body part, such that the second nozzle port is in communication with the first cavity.

In some embodiments, the reagent nozzle further has a communication opening, the communication opening is in communication with the first channel, the reagent nozzle has a first end and a second end disposed opposite each other, the first nozzle port is disposed at a second end portion of the reagent nozzle, and the second end of the reagent nozzle penetrates through the first body part; and the communication opening is disposed at a first end portion of the reagent nozzle; the spray freeze-drying device further includes: a third pipeline, a first pipe port of the third pipeline is configured to introduce nitrogen, and a second pipe port of the third pipeline is in communication with the communication opening in a docking manner; wherein the third pipeline is configured in a connected and disconnected manner; and an unclogging part, the unclogging part is disposed at the communication opening, wherein the unclogging part is elastically connected with an inner wall of a first end of the first channel, such that when nitrogen is introduced into the third pipeline, under an action of a nitrogen gas flow and an elastic force, the unclogging part reciprocates along a distribution direction of the first end and the second end of the reagent nozzle; and when the unclogging part moving towards the first nozzle port, the unclogging part unclogs frozen reagent at the first nozzle port.

In some embodiments, the reagent nozzle has a first end and a second end disposed opposite each other, the first nozzle port is disposed at the second end of the reagent nozzle, and the second end of the reagent nozzle penetrates through the first body part; the spray freeze-drying device further includes: a clamping sleeve, the clamping sleeve is sleeved on the second end of the reagent nozzle, the clamping sleeve is located on an outer side of the first body part, and the clamping sleeve contacts the first body part, the reagent nozzle and the first body part are relatively fixed; wherein the clamping sleeve has a third channel, the third channel is configured to introduce a heating medium, so that when there is frozen reagent at the first nozzle port, the heating medium introduced into the third channel heats the second end of the reagent nozzle.

In some embodiments, the sieve plate divides the second cavity into an upper cavity part and a lower cavity part, the upper cavity part and the lower cavity part are distributed along a vertical direction, and the upper cavity part is configured to be in communication with the first cavity in a docking manner; the heat exchange component is disposed in the lower cavity part; and the second body part has an exhaust port, the exhaust port is in communication with the lower cavity part.

In some embodiments, the spray freeze-drying device further includes: a reagent carrying container, a discharge port of the reagent carrying container is in communication with the reagent inlet.

In some embodiments, the spray freeze-drying device further includes: a vibrator, the vibrator is disposed on an outer side of the first body part; so that under a vibration effect of the vibrator, reagent ice droplets attached to an inner wall of the first cavity fall off from the inner wall of the first cavity.

According to another aspect of the present disclosure, a freeze-drying apparatus is provided. The freeze-drying apparatus includes an annular path, a vacuum unit and the above spray freeze-drying device, wherein the spray freeze-drying device has a plurality of second body parts, a plurality of preset positions are disposed at intervals on the annular path, and the plurality of preset positions include a freeze-drying position and at least one vacuumizing position; each of the plurality of second body parts is movably disposed along the annular path, so that each of the plurality of second body parts sequentially passes through the plurality of preset positions; by stopping movement of the plurality of second body parts, the plurality of second body parts stay at the plurality of preset positions in one-to-one correspondence; the first body part of the spray freeze-drying device is located on a side of the freeze-drying position, and the second body part at the freeze-drying position is connected with the first body part; and the first connection port of the second body part at each of the at least one vacuumizing position is configured to communicate with the air suction port of the vacuum unit.

In some embodiments, the freeze-drying apparatus further includes a multi-way valve, the multi-way valve has a plurality of connection valve ports and a main valve port, each of the plurality of connection valve ports is connected with the main valve port in a connected and disconnected manner; and the plurality of connection valve ports are connected with and in communication with the first connection ports of the plurality of second body parts at the plurality of preset positions in one-to-one correspondence, and the main valve port is connected with and in communication with the air suction port of the vacuum unit.

In some embodiments, two vacuumizing positions adjacent to the freeze-drying position are respectively an upstream vacuumizing position and a downstream vacuumizing position; the sealing cover of the spray freeze-drying device is configured to cover the upper end port of the second cavity of the second body part moving from the freeze-drying device to the downstream vacuumizing position; and when the second body part moves from the upstream vacuumizing position to the freeze-drying position, the sealing cover is detached from the second body part, so that the second body part is connected with the first body part at the freeze-drying position.

Applying the technical solution of the present disclosure, the spray freeze-drying device includes a freeze-drying component and a reagent nozzle. The freeze-drying component includes a first body part and a second body part, the first body part has a first cavity, and the second body part has a second cavity and a first connection port, the first connection port is in communication with the second cavity. The first body part is detachably connected with the second body part. When the first body part is connected with the second body part, the first cavity is in communication with the second cavity so as to jointly form a freezing cavity, and the first cavity is located above the second cavity. The reagent nozzle has a first nozzle port, a reagent inlet, a nitrogen inlet, and a first channel, and the first nozzle port, the reagent inlet, and the nitrogen inlet are all in communication with the first channel. The reagent nozzle penetrates through the first body part, so that the first nozzle port is in communication with the first cavity. The reagent inlet is configured to introduce a reagent, a preset amount of nitrogen is introduced into the first channel through the nitrogen inlet while the liquid reagent is introduced into the first channel through the reagent inlet, so that the liquid reagent entering the first channel is atomized into the liquid droplet reagent under the action of pressure generated by the preset amount of nitrogen. When the liquid droplet reagent is sprayed into the freezing cavity through the first nozzle port, reagent ice droplets are formed and then falls into the second cavity, thereby completing a spray freezing operation.

When the reagent ice droplets falling into the second cavity reach a set amount, the first body part is detached from the second body part, and the first connection port of the second body part carrying the reagent ice droplets is in communication with an air suction port of a vacuum unit, so as to evacuate the second cavity, thereby performing vacuum drying on the second cavity, i.e., performing vacuum drying on the reagent ice droplets in the second cavity.

According to the spray freeze-drying device of the present disclosure, the first body part is detachably connected with the second body part, so that one second body part can be connected with the first body part so as to perform the spray freezing operation, and another second body part can perform an evacuation operation, thereby improving the reagent preparation efficiency and solving the problem in the related art of relatively low reagent preparation efficiency of a continuous vacuum drying apparatus.

### BRIEF DESCRIPTION OF THE DRAWINGS

The drawings of the specification, which constitute a part of the present disclosure, are intended to provide a further understanding of the present disclosure, and the exemplary embodiments of the present disclosure and the description thereof are intended to explain the present disclosure and do not constitute an undue limitation on the present disclosure. In the drawings:

FIG. 1 shows a schematic structural diagram of a freeze-drying apparatus according to the present disclosure;

FIG. 2 shows a schematic structural diagram of a spray freeze-drying device according to the present disclosure;

FIG. 3 shows a structural schematic diagram of a freeze-drying component of the spray freeze-drying device in FIG. 2;

FIG. 4 shows a schematic structural diagram of a cold trap assembly of the freeze-drying apparatus in FIG. 1.

Herein, the above drawings include the following reference signs.
10, Freeze-drying component; 101, Freezing cavity; 11, First body part; 111, First cavity; 1110, Inclined wall section; 112, Liquid nitrogen nozzle; 1121, Second nozzle port; 1122, Liquid nitrogen inlet; 113, Vent; 1131, First external connection pipe; 1132, Sixth control valve; 114, Cylinder part; 115, Flange; 1161, First outer shell layer; 1162, First inner wall layer; 117, Safety valve;
120, Moving assembly; 12, Second body part; 121, Second cavity; 122, First connection port; 124, Sieve plate; 125, Heat exchange component; 126, Exhaust port; 1261, Second external connection pipe; 1262, Seventh control valve; 1271, Second outer shell layer; 1272, Second inner wall layer; 128, Side panel;
13, Sealing component; 14, First temperature detection component; 15, First pressure detection component; 171, Second temperature detection component; 1711, First sleeve; 172, Third temperature detection component; 1721, Second sleeve; 18, Sight glass;
20, Reagent nozzle; 21, First nozzle port; 22, Reagent inlet; 23, First channel; 24, Nitrogen inlet; 25, Communication opening; 26, Clamping sleeve; 261, First clamping part; 262, Second clamping part;
30, Liquid nitrogen storage tank; 31, Fifth control valve; 32, Second flow meter; 33, Fourth pipeline; 34, Fifth pipeline;
40, Nitrogen storage tank; 41, First pipeline; 411, Pressure relief valve; 412, Second control valve; 413, First flow meter; 42, Second pipeline; 421, Third control valve; 43, Third pipeline; 431, Fourth control valve;
50, Reagent carrying container; 51, Feed pump; 52, Weighing component; 53, First control valve;
60, Vibrator; 70, Temperature Control Component; 80, Heater;
90, Multi-way valve; 91, Sixth pipeline; 94, Cold trap assembly; 941, Cold trap refrigerator; 942, Cold trap; 943, Ninth control valve; 944, Tenth control valve; 945, Fourth temperature detection component; 946, Second pressure detection component; 947, Seventh pipeline; 948, Eighth control valve; 95, Third pressure detection component; 96, Eleventh control valve;
200, Vacuum unit; 210, First preset position; 220, Second preset position; 230, Third preset position; 240, Fourth preset position; 250, Fifth preset position; 260, Sixth preset position;
300, Sealing cover; 400, Material storage tank; 500, Control component.

### DETAILED DESCRIPTION OF THE EMBODIMENTS

It is to be noted that the embodiments in the present disclosure and features in the embodiments can be combined with each other without conflict. The present disclosure is described in detail below with reference to the drawings and in conjunction with the embodiments.

It is to be noted that the following detailed description is exemplary and intended to provide further explanation of the present disclosure. Unless otherwise defined, all technical and scientific terms used herein have the same meaning as commonly understood by those skilled in the art of the present disclosure.

It is to be noted that terms used herein are only for the purpose of describing the specific implementations and not intended to limit exemplary implementations of the present disclosure. For example, singular forms, used herein, are also intended to include plural forms, unless otherwise clearly pointed out. In addition, it is also to be understood that terms “contain” and/or “include” used in the specification refer/refers to existence of features, steps, operations, apparatuses, components and/or combinations thereof.

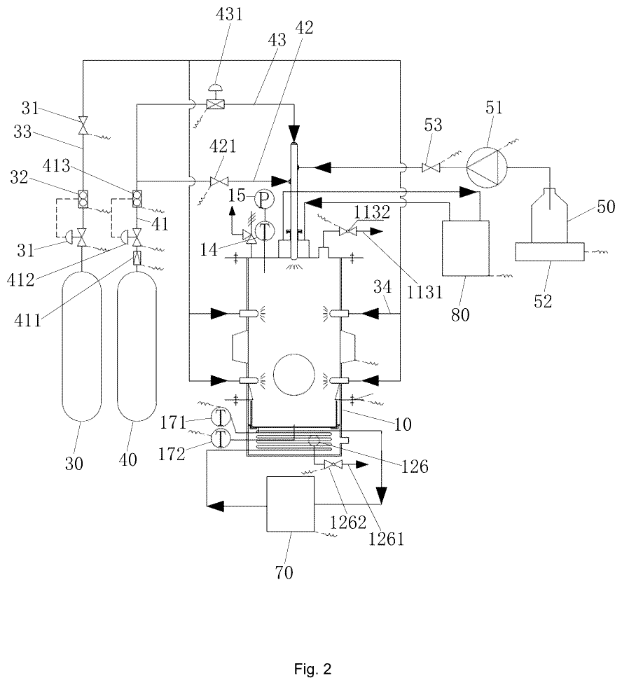

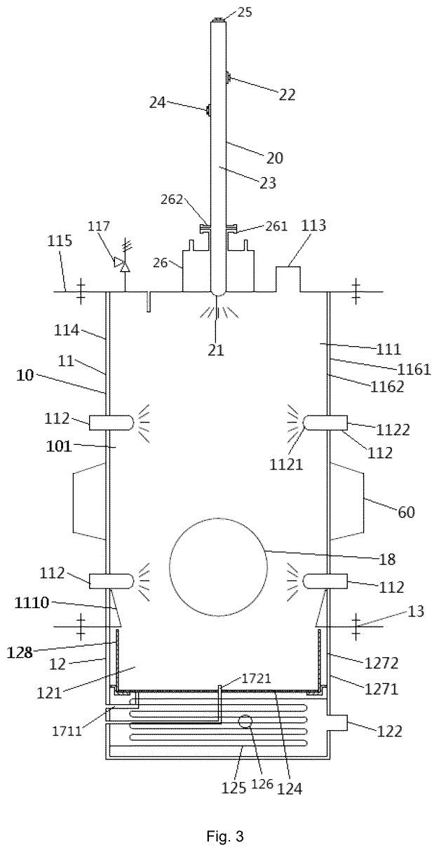

The present disclosure provides a spray freeze-drying device, referring to FIG. 2 and FIG. 3, the spray freeze-drying device includes a freeze-drying component 10 and a reagent nozzle 20. The freeze-drying component 10 includes a first body part 11 and a second body part 12, the first body part 11 has a first cavity 111, and the second body part 12 has a second cavity 121 and a first connection port 122, the first connection port 122 is in communication with the second cavity 121. The first body part 11 is detachably connected with the second body part 12. When the first body part 11 is connected with the second body part 12, the first cavity 111 is in communication with the second cavity 121 so as to jointly form a freezing cavity 101, and the first cavity 111 is located above the second cavity 121. The reagent nozzle 20 has a first nozzle port 21, a reagent inlet 22, a nitrogen inlet 24, and a first channel 23, and the first nozzle port 21, the reagent inlet 22, and the nitrogen inlet 24 are all in communication with the first channel 23. The reagent nozzle 20 penetrates through the first body part 11, so that the first nozzle port 21 is in communication with the first cavity 111. The reagent inlet 22 is configured to introduce a reagent, a preset amount of nitrogen is introduced into the first channel 23 through the nitrogen inlet 24 while the liquid reagent is introduced into the first channel 23 through the reagent inlet 22, so that the liquid reagent entering the first channel 23 is atomized into the liquid droplet reagent under the action of pressure generated by the preset amount of nitrogen. When the liquid droplet reagent is sprayed into the freezing cavity 101 through the first nozzle port 21, reagent ice droplets are formed and then falls into the second cavity 121, thereby completing a spray freezing operation.

When the reagent ice droplets falling into the second cavity 121 reach a set amount, the first body part 11 is detached from the second body part 12, and the first connection port 122 of the second body part 12 carrying the reagent ice droplets is in communication with an air suction port of a vacuum unit 200, so as to evacuate the second cavity 121, thereby performing vacuum drying on the second cavity 121, i.e., performing vacuum drying on the reagent ice droplets in the second cavity 121.

In the specific implementation process, the temperature in the freezing cavity 101 is first reduced to the required temperature, then nitrogen with a sufficient flow rate and stable pressure is introduced into the first channel 23 through the nitrogen inlet 24, and then the reagent is fed into the first channel 23 through the reagent inlet 22.

According to the spray freeze-drying device of the present disclosure, the first body part 11 is detachably connected with the second body part 12, so that one second body part 12 can be connected with the first body part 11 so as to perform the spray freezing operation, and another second body part 12 can perform an evacuation operation, thereby improving the reagent preparation efficiency and solving the problem in the related art of relatively low reagent preparation efficiency of a continuous vacuum drying apparatus. According to the spray freeze-drying device of the present disclosure, spraying, freezing and drying processes are integrated in the same cavity, so as to achieve the integration of spraying, freezing and drying.

In some embodiments, a spray angle of the first nozzle port 21 of the reagent nozzle 20 is relatively small, for example, the spray angle of the first nozzle port 21 of the reagent nozzle 20 is 15 degrees to 30 degrees, which is conducive to enabling the first cavity 111 with a relatively small cross section to meet usage requirements, thereby reducing the volume of the device.

In some embodiments, an upper end of the second cavity 121 is open, and a lower end of the first cavity 111 is open. When the first body part 11 is connected with the second body part 12, a lower end port of the first cavity 111 is in butt-joint communication with an upper end port of the second cavity 121. The spray freeze-drying device further includes a sealing cover 300. After the first body part 11 is detached from the second body part 12, the sealing cover 300 is configured to cover the upper end port of the second cavity 121, so that the second cavity 121 forms a sealed cavity, thereby facilitating the evacuation of the second cavity 121.

In some embodiments, the sealing cover 300 is powered by hydraulic pressure, so as to drive the sealing cover 300 to be configured to cover the second body part 12 and be detached from the second body part 12.

In some embodiments, the reagent nozzle 20 is of a strip structure, and the reagent nozzle 20 extends in a vertical direction.

In some embodiments, the spray freeze-drying device further includes a sieve plate 124. The sieve plate 124 is disposed in the second cavity 121, and the sieve plate 124 is spaced apart from a bottom wall of the second cavity 121, so that the reagent ice droplets entering the second cavity 121 fall onto the sieve plate 124. When the reagent ice droplets on the sieve plate 124 reach the set amount, the first body part 11 is detached from the second body part 12, and the first connection port 122 of the second body part 12 carrying the reagent ice droplets is in communication with the air suction port of the vacuum unit 200, so as to evacuate the second cavity 121.

Through the arrangement of the sieve plate 124, the sieve plate 124 can trap the reagent ice droplets, and the reagent ice droplets are retained on the sieve plate 124. The nitrogen can enter a space between the sieve plate 124 and the bottom wall of the second cavity 121 through sieve holes of the sieve plate 124.

In some embodiments, the sieve plate 124 has a plurality of sieve holes distributed at intervals, each of the plurality of sieve holes penetrates through two plate surfaces of the sieve plate 124. The aperture of the sieve holes is less than the particle size of the reagent ice droplets, so that the sieve plate 124 can trap the reagent ice droplets.

In some embodiments, the thickness of the reagent ice droplets on the sieve plate 124 is controlled by controlling the time and flow rate of the liquid reagent introduced into the reagent inlet 22, thereby controlling whether the reagent ice droplets on the sieve plate 124 reach the set amount.

In the specific implementation process, when the reagent ice droplets on the sieve plate 124 reach the set amount, firstly the reagent is stopped from being fed into the first channel 23, and then the nitrogen is stopped from being introduced into the first channel 23.

In some embodiments, the sieve plate 124 is detachably connected with the inner wall of the second cavity 121, so that the sieve plate 124 is mounted in the second cavity 121 or removed from the second cavity 121.

In some embodiments, the spray freeze-drying device further includes a heat exchange component 125. The heat exchange component 125 is disposed in the second cavity 121, and the heat exchange component 125 is located between the sieve plate 124 and the bottom wall of the second cavity 121. When the first body part 11 is connected with the second body part 12, the heat exchange medium in the heat exchange component 125 is a cooling medium, so that the internal temperature of the freezing cavity 101 is controlled by the heat exchange component 125. When the first body part 11 is detached from the second body part 12, the internal temperature of the second cavity 121 is controlled by the heat exchange component 125, and at this time, the heat exchange medium in the heat exchange component 125 is the cooling medium or a heating medium.

In some embodiments, the heat exchange component 125 is a heat exchange coil.

In some embodiments, at least part of the heat exchange component 125 is in contact with the sieve plate 124.

In some embodiments, the spray freeze-drying device further includes a temperature control component 70. The temperature control component 70 is connected with the heat exchange component 125, so as to control the temperature of a heat exchange medium in the heat exchange component 125, so that the heat exchange medium is the cooling medium or the heating medium. In the specific implementation process, when vacuum drying is performed, the temperature of the heat exchange medium is controlled by the temperature control component 70 according to a set drying temperature curve.

For example, the temperature control component 70 is a high and low temperature integrated machine.

In some embodiments, the heat exchange coil has a medium inlet and a medium outlet, the temperature control component 70 has a medium inlet and a medium outlet, the medium outlet of the temperature control component 70 is in communication with the medium inlet of the heat exchange coil, and the medium outlet of the heat exchange coil is in communication with the medium inlet of the temperature control component 70, so as to form a medium cycle, thereby achieving the purpose of controlling the temperature of the heat exchange medium in the heat exchange component 125 by the temperature control component 70.

In some embodiments, the spray freeze-drying device further includes a liquid nitrogen nozzle 112. The liquid nitrogen nozzle 112 has a second nozzle port 1121, a liquid nitrogen inlet 1122, and a second channel, and the second nozzle port 1121 and the liquid nitrogen inlet 1122 are both in communication with the second channel. The liquid nitrogen nozzle 112 penetrates through the first body part 11, so that the second nozzle port 1121 is in communication with the first cavity 111, and the liquid nitrogen entering the second channel is sprayed into the first cavity 111 through the second nozzle port 1121. By spraying the liquid nitrogen into the first cavity 111, the temperature in the freezing cavity 101 can be quickly reduced to a predetermined temperature, and the internal temperature of the first cavity 111 can be relatively low.

In the specific implementation process, the liquid nitrogen is continuously sprayed into the first cavity 111, so as to promptly and effectively solve the problem of a temperature rise in the first cavity 111 due to the heat release caused by the phase change of the reagent from the liquid droplets to the ice droplets.

In addition, since the temperature of the freezing cavity 101 can be relatively low by spraying the liquid nitrogen into the first cavity 111, the vertical height of the freezing cavity 101 can be reduced, thereby reducing the device size of the freeze-drying component 10 and saving the manufacturing cost of the device.

In the specific implementation process, the liquid nitrogen is first sprayed into the first cavity 111 for pre-cooling, then the nitrogen is introduced into the first channel 23 through the nitrogen inlet 24, and then the liquid reagent is introduced into the first channel 23 through the reagent inlet 22. The pre-cooling time can be reduced by spraying the liquid nitrogen into the first cavity 111 for cooling.

In the specific implementation process, when the reagent ice droplets on the sieve plate 124 reach the set amount, firstly the reagent is stopped from being fed into the first channel 23, then the nitrogen is stopped from being introduced into the first channel 23, and then the liquid nitrogen is stopped from being sprayed into the first cavity 111.

In the specific implementation process, before stopping spraying the liquid nitrogen into the first cavity 111, the temperature of the cooling medium in the heat exchange component 125 is reduced to a set temperature in advance. The set temperature is generally less than a eutectic point of the reagent, and a difference between the set temperature and the eutectic point of the reagent ranges from 5 °C to 10 °C, so as to avoid melting and collapse of the reagent ice droplets on the sieve plate 124.

In some embodiments, the spray freeze-drying device further includes a liquid nitrogen storage tank 30. An outlet of the liquid nitrogen storage tank 30 is in communication with the liquid nitrogen inlet 1122, so that the liquid nitrogen in the liquid nitrogen storage tank 30 enters the second channel through the outlet thereof and the liquid nitrogen inlet 1122. In some embodiments, the liquid nitrogen storage tank 30 is a liquid nitrogen Dewar tank.

In some embodiments, a plurality of liquid nitrogen nozzles 112 are provided, and the liquid nitrogen inlet 1122 of each of the plurality of liquid nitrogen nozzles 112 is in communication with the outlet of the liquid nitrogen storage tank 30.

In some embodiments, the plurality of liquid nitrogen nozzles 112 are divided into a plurality of nozzle groups, each of the plurality of nozzle groups includes the plurality of liquid nitrogen nozzles 112, the plurality of nozzle groups are distributed at intervals in the vertical direction, and the plurality of liquid nitrogen nozzles 112 of each nozzle group are disposed at intervals in a circumferential direction of the first cavity 111.

In some embodiments, a connection pipeline between the outlet of the liquid nitrogen storage tank 30 and the liquid nitrogen inlet 1122 is configured with a fifth control valve 31, so as to control the connection and disconnection between the outlet of the liquid nitrogen storage tank 30 and the liquid nitrogen inlet 1122, and control the flow rate of the liquid nitrogen flow in the connection pipeline between the outlet of the liquid nitrogen storage tank 30 and the liquid nitrogen inlet 1122.

In some embodiments, two fifth control valves 31 are provided, and the two fifth control valves 31 are respectively an electric control valve and an electric ball valve.

In some embodiments, the connection pipeline between the outlet of the liquid nitrogen storage tank 30 and the liquid nitrogen inlet 1122 is configured with a second flow meter 32, so as to detect the flow rate of the liquid nitrogen in the connection pipeline between the outlet of the liquid nitrogen storage tank 30 and the liquid nitrogen inlet 1122.

In some embodiments, the spray freeze-drying device further includes a fourth pipeline 33 and a plurality of fifth pipelines 34. A first pipe port of the fourth pipeline 33 is connected with and in communication with the outlet of the liquid nitrogen storage tank 30, and first pipe ports of the plurality of fifth pipelines 34 are all connected with and in communication with a second pipe port of the fourth pipeline 33. The plurality of fifth pipelines 34 and the plurality of liquid nitrogen nozzles 112 are disposed in a one-to-one correspondence manner, and a second pipe port of each fifth pipeline 34 is connected with and in communication with the liquid nitrogen inlet 1122 of the corresponding liquid nitrogen nozzle 112. That is, the plurality of fifth pipelines 34 are disposed in parallel. The two fifth control valves 31 and the second flow meter 32 are both disposed on the fourth pipeline 33.

In some embodiments, the spray freeze-drying device further includes a nitrogen storage tank 40. A gas outlet of the nitrogen storage tank 40 is in communication with the nitrogen inlet 24, so that the nitrogen in the nitrogen storage tank 40 enters the first channel 23 through the gas outlet thereof and the nitrogen inlet 24. In some embodiments, the nitrogen storage tank 40 is a nitrogen cylinder.

In some embodiments, the reagent nozzle 20 further has a communication opening 25 in communication with the first channel 23. The reagent nozzle 20 has a first end and a second end which are disposed opposite each other, the first nozzle port 21 is disposed at the second end portion of the reagent nozzle 20, and the second end of the reagent nozzle 20 penetrates through the first body part 11. The communication opening 25 is disposed at the first end portion of the reagent nozzle 20. The spray freeze-drying device further includes a third pipeline 43 and an unclogging part. A first pipe port of the third pipeline 43 is configured to introduce the nitrogen, and a second pipe port of the third pipeline 43 is in butt-joint communication with the communication opening 25. The third pipeline 43 is configured in a connected and disconnected manner. The unclogging part is disposed at the communication opening 25, and the unclogging part is elastically connected with an inner wall of a first end of the first channel 23, so that the unclogging part can move elastically and telescopically in a distribution direction of the first end and the second end of the reagent nozzle 20. When the nitrogen is introduced into the third pipeline 43, the nitrogen gas flow can generate a certain pressure and acting force on the unclogging part, that is, under the action of the nitrogen gas flow and the elastic force, the unclogging part can be driven to reciprocate in the distribution direction of the first end and the second end of the reagent nozzle 20, and when the unclogging part moves toward the first nozzle port 21, the unclogging part unclogs frozen reagent at the first nozzle port 21. That is, the unclogging part pokes the frozen reagent at the first nozzle port 21, thereby achieving unclogging of the first nozzle port 21.

In some embodiments, the first channel 23 extends in the distribution direction of the first end and the second end of the reagent nozzle 20. The first channel 23 has a first end and a second end which are disposed opposite each other in an extension direction of the first channel 23. A direction from the first end to the second end of the first channel 23 is the same as a direction from the first end to the second end of the reagent nozzle 20.

In some embodiments, the unclogging part is an unclogging needle, and an extension direction of the unclogging needle is parallel to or the same as the distribution direction of the first end and the second end of the reagent nozzle 20.

In some embodiments, the third pipeline 43 is configured with a fourth control valve 431, so as to control the connection and disconnection of the third pipeline 43 through the fourth control valve 431. In some embodiments, the fourth control valve 431 is a pneumatic solenoid valve. The movement frequency of the unclogging part is controlled by controlling the switching frequency of the fourth control valve 431.

In some embodiments, when the third pipeline 43 is in a disconnected state, part of the unclogging part extends out of the communication opening 25 and extends into the third pipeline 43.

In some embodiments, the unclogging part is connected with the inner wall of the first end of the first channel 23 through an elastic component, and an expansion and contraction direction of the elastic component is parallel to the distribution direction of the first end and the second end of the reagent nozzle 20.

Further, in the expansion and contraction direction of the elastic component, the elastic component has a first end and a second end which are disposed opposite each other, and the first end and the second end of the elastic component are respectively fixedly connected with the unclogging part and the inner wall of the first end of the first channel 23.

In some embodiments, when the reagent nozzle 20 is of a strip structure, the extension direction of the reagent nozzle 20 is the same as the distribution direction of the first end and the second end of the reagent nozzle 20. When the reagent nozzle 20 extends in the vertical direction, an upper end of the reagent nozzle 20 is the first end thereof, and a lower end of the reagent nozzle 20 is the second end thereof.

In this embodiment, the nitrogen is introduced into the first channel 23 through a pipeline connected with the nitrogen inlet 24, and the pipeline connected with the nitrogen inlet 24 is configured in a connected and disconnected manner.

In some embodiments, a connection pipeline between the gas outlet of the nitrogen storage tank 40 and the nitrogen inlet 24 is configured in a connected and disconnected manner, and the first pipe port of the third pipeline 43 is in communication with the gas outlet of the nitrogen storage tank 40.

In some embodiments, the spray freeze-drying device further includes a first pipeline 41 and a second pipeline 42. A first pipe port of the first pipeline 41 is connected with and in communication with the gas outlet of the nitrogen storage tank 40, a first pipe port of the second pipeline 42 and the first pipe port of the third pipeline 43 are both connected with and in communication with a second pipe port of the first pipeline 41, a second pipe port of the second pipeline 42 is connected with and in communication with the nitrogen inlet 24, and the second pipe port of the third pipeline 43 is connected with and in communication with the communication opening 25. That is, the second pipeline 42 and the third pipeline 43 are disposed in parallel.

In some embodiments, the first pipeline 41 is configured with a pressure relief valve 411, so as to reduce the pressure of the nitrogen flowing out of the gas outlet of the nitrogen storage tank 40.

In some embodiments, the first pipeline 41 is configured with a second control valve 412, so as to control the connection and disconnection of the first pipeline 41, and adjust the flow rate of the nitrogen in the first pipeline 41 through the second control valve 412. In some embodiments, the second control valve 412 is electric control valve.

In some embodiments, the first pipeline 41 is configured with a first flow meter 413, so as to detect the flow rate of the nitrogen in the first pipeline 41. By arranging the second control valve 412 and the first flow meter 413, the accurate flow rate of the nitrogen and the sufficient nitrogen pressure are provided for the reagent nozzle 20 through the nitrogen inlet 24, thereby ensuring that the reagent can be atomized into sufficiently small liquid droplets of a particular size.

In some embodiments, the second pipeline 42 is configured with a third control valve 421, so as to control the connection and disconnection of the second pipeline 42, and adjust the flow rate of the nitrogen in the second pipeline 42 through the third control valve 421. In some embodiments, the third control valve 421 is an electric ball valve.

In some embodiments, the nitrogen inlet 24 and the reagent inlet 22 are disposed on a side of the reagent nozzle 20, and both the nitrogen inlet 24 and the reagent inlet 22 are disposed close to the first end of the reagent nozzle 20.

In some embodiments, the spray freeze-drying device further includes a clamping sleeve 26. The clamping sleeve 26 is sleeved on the second end of the reagent nozzle 20, the clamping sleeve 26 is located on an outer side of the first body part 11 and is in contact with the first body part 11, so that the reagent nozzle 20 and the first body part 11 are relatively fixed.

The clamping sleeve 26 has a third channel, and the third channel is configured to introduce a heating medium, so that when there is frozen reagent at the first nozzle port 21, the heating medium introduced into the third channel heats the second end of the reagent nozzle 20, so as to melt the frozen reagent at the first nozzle port 21, thereby unclogging the first nozzle port 21. In some embodiments, the heating medium introduced into the third channel is oil, for example, the heating medium introduced into the third channel is heat transfer oil.

Since the temperature in the freezing cavity 101 is relatively low, part of the reagent may freeze at the first nozzle port 21, and the frozen reagent at the first nozzle port 21 may cause the first nozzle port 21 to be blocked. If the requirement of the reagent for the temperature sensitivity is not very strict, that is, the reagent is not denatured at high temperature, then when the frozen reagent exists at the first nozzle port 21, the first nozzle port 21 can be unclogged by introducing the heating medium into the third channel. If the requirement of the reagent for the temperature sensitivity is very strict, that is, the reagent is denatured at high temperature, and the first nozzle port 21 is unclogged by moving the unclogging part in the distribution direction of the first end and the second end of the reagent nozzle 20.

In some embodiments, the spray freeze-drying device further includes a heater 80. The heater 80 has a medium inlet and a medium outlet, the medium outlet of the heater 80 is connected with and in communication with a first end port of the third channel, and the medium inlet of the heater 80 is connected with and in communication with a second end port of the third channel, so that the heating medium heated by the heater 80 enters into the third channel through the medium outlet of the heater 80 and the first end port of the third channel, so as to heat the second end of the reagent nozzle 20, and the medium in the third channel that heats the second end of the reagent nozzle 20 enters into the heater 80 through the second end port of the third channel and the medium inlet of the heater 80, so as to form a heating cycle.

In some embodiments, the clamping sleeve 26 is welded with the first body part 11.

In some embodiments, the clamping sleeve 26 includes a first clamping part 261, a second clamping part 262, and a locking part. The first clamping part 261 has a first sleeve hole penetrating through the first clamping part 261 in a preset direction, and the second clamping part 262 has a second sleeve hole penetrating through the second clamping part 262 in a preset direction. The first clamping part 261 is fixedly connected with the first body part 11, and the first clamping part 261 is detachably connected with the second clamping part 262. When the first clamping part 261 is connected with the second clamping part 262, the first sleeve hole is in butt-joint communication with the second sleeve hole, so that the reagent nozzle 20 penetrates through the first sleeve hole and the second sleeve hole, and the clamping sleeve 26 is sleeved on the reagent nozzle 20. At this time, the first clamping part 261 and the second clamping part 262 are locked by the locking part, so that the second clamping part 262 is in interference fit with the reagent nozzle 20 therein, so as to fix and support the reagent nozzle 20. When disassembling, the locking part is detached from the first clamping part 261 and the second clamping part 262, so that the first clamping part 261 is detached from the second clamping part 262, thereby facilitating the replacement of the reagent nozzle 20. In addition, the appropriate second clamping part 262 can be selected for the reagent nozzles 20 of different specifications. Since the first clamping part 261 is detachably connected with the second clamping part 262, the spray freeze-drying device can be applied to the reagent nozzles 20 of different specifications, thereby having high versatility. In some embodiments, the locking part is a hoop.

In some embodiments, the reagent nozzle 20 of the appropriate specification is selected according to the reagent. For example, the requirements for the range of aerodynamic diameters of reagent particles for different purposes are different, and the specifications of the applicable reagent nozzles 20 are also different.

It is to be noted that the cross section of the reagent nozzle 20 perpendicular to the extension direction thereof is circular, and the reagent nozzles 20 of different specifications refer to the reagent nozzles 20 having different diameters of the cross sections perpendicular to the extension direction thereof.

In some embodiments, the spray freeze-drying device further includes a reagent carrying container 50 for carrying the reagent. A discharge port of the reagent carrying container 50 is in communication with the reagent inlet 22, so as to introduce the reagent into the first channel 23 through the reagent inlet 22.

In some embodiments, a connection pipeline between the discharge port of the reagent carrying container 50 and the reagent inlet 22 is configured with a feed pump 51, so that the reagent in the reagent carrying container 50 is fed into the first channel 23 under the action of the feed pump 51.

In some embodiments, the spray freeze-drying device further includes a weighing component 52. The weighing component 52 is configured to weigh the reagent in the reagent carrying container 50 placed on the weighing component 52, so as to feed a predetermined amount of the reagent into the first channel 23. In some embodiments, the weighing component 52 is a scale.

In some embodiments, the connection pipeline between the discharge port of the reagent carrying container 50 and the reagent inlet 22 is configured with a first control valve 53, so as to control the connection and disconnection between the discharge port of the reagent carrying container 50 and the reagent inlet 22 through the first control valve 53, and control the flow rate of the reagent in the connection pipeline between the discharge port of the reagent carrying container 50 and the reagent inlet 22. In some embodiments, the first control valve 53 is an electric ball valve.

In some embodiments, the reagent carrying container 50 is configured with a liquid level scale, so as to obtain a liquid level of the reagent in the reagent carrying container 50, and further to determine whether the amount of the reagent in the reagent carrying container 50 meets the amount required for operation, thereby avoiding the problem of the waste of the reagent caused by the interruption of the operation of the device due to insufficient reagent in the reagent carrying container 50 or abnormal feeding into the first channel 23.

In some embodiments, the spray freeze-drying device further includes a vibrator 60. The vibrator 60 is disposed on the outer side of the first body part 11, so that the reagent ice droplets attached to an inner wall of the first cavity 111 fall off from the inner wall of the first cavity 111 under the vibration effect of the vibrator 60, so as to reduce the waste of the reagent.

In some embodiments, when the first body part 11 is connected with the second body part 12, a connection position between the first body part 11 and the second body part 12 is configured with a sealing component 13, so as to ensure the sealing performance of the freezing cavity 101.

In some embodiments, the sealing component 13 is of a sealing structure in the form of a chuck.

In some embodiments, the spray freeze-drying device further includes a side panel 128. The side panel 128 is of a cylindrical structure and extends in the vertical direction, a bottom end of the side panel 128 is connected with the sieve plate 124, and an upper end port of the side panel 128 is open, so that the reagent ice droplets in the freezing cavity 101 pass through the upper end port of the side panel 128 and fall onto the sieve plate 124.

In some embodiments, the side panel 128 and the sieve plate 124 are of an integrally formed structure.

In some embodiments, a cavity wall at the lower end of the first cavity 111 includes an inclined wall section 1110. From an upper end to a lower end of the inclined wall section 1110, a wall surface of the inclined wall section 1110 gradually approaches a central axis of the first cavity 111. The inclined wall section 1110 extends in the circumferential direction of the first cavity 111 and is connected end to end to form an annular structure. The central axis of the first cavity 111 extends in the vertical direction. A top end of the side panel 128 is located on a side of a bottom end of the inclined wall section 1110 away from the central axis of the first cavity 111, so as to ensure that the reagent ice droplets sliding along the cavity wall of the first cavity 111 can pass through a cylinder cavity of the side panel 128 and fall onto the sieve plate 124.

In some embodiments, the spray freeze-drying device further includes a first temperature detection component 14. At least part of the first temperature detection component 14 is disposed in the freezing cavity 101, so as to detect the temperature in the freezing cavity 101. In some embodiments, the first temperature detection component 14 is a thermometer.

In some embodiments, the sieve plate 124 divides the second cavity 121 into an upper cavity part and a lower cavity part distributed up and down in the vertical direction. At least part of the first temperature detection component 14 is disposed in the first cavity 111 or the upper cavity part.

In some embodiments, the spray freeze-drying device further includes a first pressure detection component 15. At least part of the first pressure detection component 15 is disposed in the freezing cavity 101, so as to detect the pressure in the freezing cavity 101. In some embodiments, the first pressure detection component 15 includes a pressure gage. In some embodiments, at least part of the first pressure detection component 15 is disposed in the first cavity 111 or the upper cavity part.

In some embodiments, the first body part 11 further has a vent 113 in communication with the first cavity 111, and the vent 113 can be opened and closed. When the first pressure detection component 15 detects that the pressure in the freezing cavity 101 is greater than or equal to a first preset pressure value, the vent 113 can be opened to release gas through the vent 113, thereby achieving the effect of timely releasing the pressure of the freezing cavity 101, so that the pressure in the freezing cavity 101 is less than the first preset pressure value. For example, when the first body part 11 and second body part 12 which are connected are detached, if the first pressure detection component 15 detects that the pressure in the freezing cavity 101 is greater than or equal to the first preset pressure value at this time, the pressure can be released through the vent 113, so as to detach the first body part 11 from the second body part 12.

In some embodiments, the vent 113 is disposed at the top of the first body part 11.

In some embodiments, the spray freeze-drying device further includes a first external connection pipe 1131. The first external connection pipe 1131 is connected with and in communication with the vent 113. The first external connection pipe 1131 is configured with a sixth control valve 1132, so as to control the connection and disconnection of the first external connection pipe 1131 and control the flow rate of the gas in the first external connection pipe 1131 through the sixth control valve 1132. In some embodiments, the sixth control valve 1132 is a ball valve.

In some embodiments, the first body part 11 is configured with a preset opening, and the preset opening is configured with a safety valve 117. When the pressure in the freezing cavity 101 is greater than or equal to a second preset pressure value, the pressure in the freezing cavity 101 is too high to release the pressure through the vent 113 in time, and the pressure in the freezing cavity 101 can push the safety valve 117 open, that is, the safety valve 117 jumps to open the preset opening, thereby rapidly releasing the pressure of the freezing cavity 101. The second preset pressure value is greater than the first preset pressure value.

In some embodiments, the preset opening is disposed at the top of the first body part 11.

In some embodiments, the spray freeze-drying device further includes a second temperature detection component 171. At least part of the second temperature detection component 171 is connected with a bottom surface of the sieve plate 124, so as to detect the temperature of the bottom surface of the sieve plate 124 in real time, and then timely adjust the cooling capacity of the heat exchange component 125 according to the temperature of the bottom surface of the sieve plate 124, thereby preventing the collapse of the reagent ice droplets on the sieve plate 124. In some embodiments, the second temperature detection component 171 includes a patch thermometer attached to the bottom surface of the sieve plate 124.

In some embodiments, the spray freeze-drying device further includes a first sleeve 1711. One end of the first sleeve 1711 extends to the bottom surface of the sieve plate 124, and the other end of the first sleeve 1711 extends to an outer wall surface of the second body part 12. At least part of the second temperature detection component 171 is located in the first sleeve 1711.

In some embodiments, the spray freeze-drying device further includes a third temperature detection component 172. At least part of the third temperature detection component 172 extends out of the sieve plate 124 to be in contact with the reagent ice droplets on the sieve plate 124, so as to detect the temperature of the reagent ice droplets on the sieve plate 124 in real time, and then timely adjust the cooling capacity of the heat exchange component 125 according to the temperature of the reagent ice droplets on the sieve plate 124, thereby preventing the collapse of the reagent ice droplets on the sieve plate 124. In some embodiments, the third temperature detection component 172 includes a thermometer.

In some embodiments, the spray freeze-drying device further includes a second sleeve 1721. One end of the second sleeve 1721 extends toward the sieve plate 124 and extends to above the sieve plate 124, and the other end of the second sleeve 1721 extends to the outer wall surface of the second body part 12. At least part of the third temperature detection component 172 is located in the second sleeve 1721.

In some embodiments, the sieve plate 124 divides the second cavity 121 into the upper cavity part and the lower cavity part which are distributed up and down in the vertical direction, the upper cavity part is configured to butt-joint communication with the first cavity 111. The heat exchange component 125 is disposed in the lower cavity part.

The second body part 12 has an exhaust port 126 in communication with the lower cavity part. Since the liquid nitrogen sprayed into the first cavity 111 has a vaporization phenomenon, and the nitrogen introduced into the first channel 23 through the nitrogen inlet 24 may enter into the first cavity 111, at this time, the nitrogen in the freezing cavity 101 can be discharged through the exhaust port 126. The exhaust port 126 is in communication with the lower cavity part, which is helpful for the cold air generated by the liquid nitrogen to pass through the first cavity 111 and the upper cavity part, and further is conductive to ensuring that the temperature of the upper cavity part is sufficiently low, thereby being conductive to ensuring that the reagent ice droplets on the sieve plate 124 are in a sufficiently low environment.

In some embodiments, the spray freeze-drying device further includes a second external connection pipe 1261. A pipe port of the second external connection pipe 1261 is connected with and in communication with the exhaust port 126. The second external connection pipe 1261 is configured with a seventh control valve 1262, so as to control the connection and disconnection of the second external connection pipe 1261 and control the flow rate of the gas in the second external connection pipe 1261 through the seventh control valve 1262. In some embodiments, the seventh control valve 1262 is a ball valve.

In some embodiments, the first body part 11 includes a cylinder part 114 and a flange 115. The flange 115 is configured to fixedly cover an upper end port of the cylinder part 114, and a lower end port of the cylinder part 114 is the lower end port of the first cavity 111. The second end of the reagent nozzle 20 penetrates through the flange 115, and the clamping sleeve 26 is configured to contact with the flange 115. The vent 113 and the preset opening are disposed on the flange 115.

In some embodiments, the first body part 11 includes a first outer shell layer 1161 and a first inner wall layer 1162 located on an inner side of the first outer shell layer 1161. The first inner wall layer 1162 is the cavity wall of the first cavity 111, and the first outer shell layer 1161 and the first inner wall layer 1162 are spaced apart. A space between the first outer shell layer 1161 and the first inner wall layer 1162 is evacuated, so that the space between the first outer shell layer 1161 and the first inner wall layer 1162 forms a vacuum insulation layer, thereby ensuring the insulation effect of the first cavity 111.

In some embodiments, the second body part 12 includes a second outer shell layer 1271 and a second inner wall layer 1272 located on an inner side of the second outer shell layer 1271. The second inner wall layer 1272 is the cavity wall of the second cavity 121, and the second outer shell layer 1271 and the second inner wall layer 1272 are spaced apart. A space between the second outer shell layer 1271 and the second inner wall layer 1272 is evacuated, so that the space between the second outer shell layer 1271 and the second inner wall layer 1272 forms a vacuum insulation layer, thereby ensuring the insulation effect of the second cavity 121.

In some embodiments, the first body part 11 further has a mounting opening in communication with the first cavity 111, and the spray freeze-drying device further includes a sight glass 18. The sight glass 18 is mounted at the mounting opening, so that the internal situation of the freezing cavity 101 is observed through the sight glass 18, and then the freezing process and the freezing effect of the reagent liquid droplets in the freezing cavity 101 can be observed. A circumferential edge of the sight glass 18 is sealed with a circumferential wall surface of the mounting opening, so as to ensure the sealing performance of the freezing cavity 101.

In some embodiments, the mounting opening is located at a lower part of the first body part 11, so as to facilitate observation of the freezing effect of the reagent ice droplets falling onto the sieve plate 124 in the freezing cavity 101.

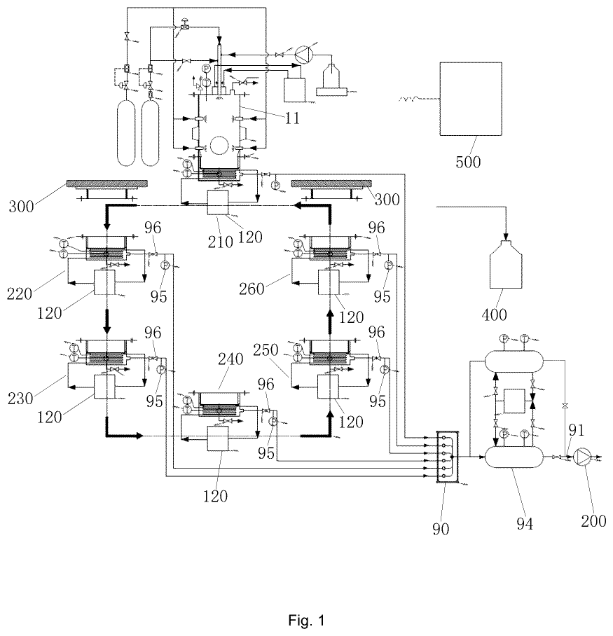

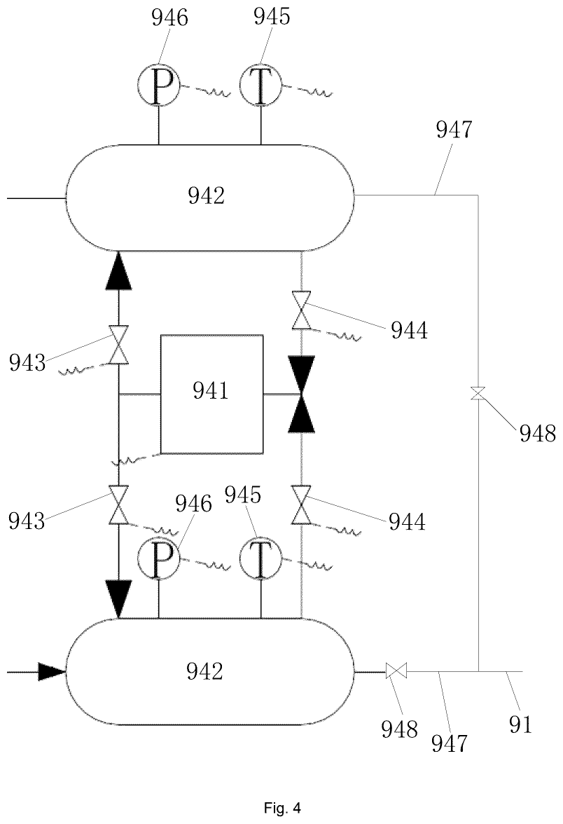

The present disclosure further provides a freeze-drying apparatus, as shown in FIG. 1 to FIG. 4, the freeze-drying apparatus includes an annular path, a vacuum unit 200, and the above spray freeze-drying device. The spray freeze-drying device has a plurality of second body parts 12. The annular path is configured with a plurality of preset positions at intervals, and the plurality of preset positions include a freeze-drying position and at least one vacuumizing position. Each of the plurality of second body parts 12 is movably disposed along the annular path, so that each of the plurality of second body parts 12 passes through the plurality of preset positions in sequence, and then reagent ice droplets in each of the plurality of second body parts 12 are subjected to a plurality of stages of vacuum drying. By stopping the movement of the plurality of second body parts 12, the plurality of second body parts 12 stay at the plurality of preset positions in a one-to-one correspondence manner. The first body part 11 of the spray freeze-drying device is located on a side of the freeze-drying position, and the second body part 12 at the freeze-drying position is connected with the first body part 11, so as to perform the spray freezing operation. The first connection port 122 of the second body part 12 at each vacuumizing position is configured to communication with the air suction port of the vacuum unit 200, so as to evacuate the second cavity 121 of the second body part 12 at each vacuumizing position, and then perform vacuum drying on the second cavity 121 of the second body part 12 at each vacuumizing position.

In some embodiments, when a plurality of vacuumizing positions are provided, the vacuum drying temperatures in the second cavities 121 of the second body parts 12 at any two adjacent vacuumizing positions are different.

It is to be noted that the vacuum drying temperature in the second cavity 121 refers to the temperature in the second cavity 121 when the second cavity 121 is evacuated.

In the related art, a periodic vacuum drying apparatus changes the temperature of the apparatus once for each production cycle, resulting in part of the energy being wasted on repeated heating of apparatus components, thereby greatly wasting the energy. However, the freeze-drying apparatus of the present disclosure is configured with the plurality of vacuumizing positions, so as to perform a plurality of stages of vacuum drying steps, which can avoid the problem of energy waste caused by repeated heating. In some embodiments, the freeze-drying apparatus is a continuous spray freeze-drying apparatus.

In some embodiments, the spray freeze-drying device includes a plurality of moving assemblies 120. Each of the plurality of moving assemblies 120 includes a second body part 12, a sieve plate 124, a heat exchange component 125, a temperature control component 70, a second temperature detection component 171, a third temperature detection component 172, a second external connection pipe 1261, and a seventh control valve 1262.

In the specific implementation process, in each moving assembly 120, the temperature of a heat exchange medium in the heat exchange component 125 is controlled by the temperature control component 70, thereby controlling the vacuum drying temperature of the second cavity 121.

In some embodiments, the vacuum unit 200 includes a vacuum pump.

In some embodiments, when an evacuation operation is performed on the second cavity 121, the vacuum degree in the second cavity 121 is controlled to be 10 Pa to 100 Pa.

In the specific implementation process, the two vacuumizing positions adjacent to the freeze-drying position are respectively an upstream vacuumizing position and a downstream vacuumizing position. In a movement direction of each second body part 12 on the annular path, the vacuumizing position adjacent to the freeze-drying position and located upstream of the freeze-drying position is the upstream vacuumizing position, and the vacuumizing position adjacent to the freeze-drying position and located downstream of the freeze-drying position is the downstream vacuumizing position. The sealing cover 300 of the spray freeze-drying device is configured to cover the upper end port of the second cavity 121 of the second body part 12 moving from the freeze-drying device to the downstream vacuumizing position. That is, when the second body part 12 moves from the freeze-drying device to the downstream vacuumizing position, the sealing cover 300 covers the second body part 12, so as to ensure the sealing performance of the second cavity 121 of the second body part 12, and ensure that the second cavity 121 is a sealed cavity when the second body part 12 is evacuated at the downstream vacuumizing position and each subsequent vacuumizing position. When the second body part 12 moves from the upstream vacuumizing position to the freeze-drying position, the sealing cover 300 is detached from the second body part 12, and reagent powder or reagent particles in the second cavity 121 of the second body part 12 are taken away, and then the second body part 12 is connected with the first body part 11 at the freeze-drying position.

In some embodiments, after the plurality of stages of vacuum drying, the reagent ice droplets form the reagent powder or reagent particles. It is to be noted that the aperture of the sieve holes of the sieve plate 124 is less than the particle size of the reagent powder or reagent particles, so as to avoid the problem of the reagent powder or reagent particles falling from the sieve holes of the sieve plate 124.

In some embodiments, when the second body part 12 moves from the upstream vacuumizing position to the freeze-drying position, the pressure in the second cavity 121 of the second body part 12 is restored to the atmospheric pressure, so that the sealing cover 300 is detached from the second body part 12.

In some embodiments, the freeze-drying apparatus further includes a material storage tank 400. The reagent powder or reagent particles in the second body part 12 moving from the upstream vacuumizing position to the freeze-drying position after passing through all the vacuumizing positions are transferred into the material storage tank 400.

In some embodiments, the freeze-drying apparatus further includes a conveyor belt. The annular path is disposed on the conveyor belt, and the plurality of second body parts 12 are all disposed on the conveyor belt, so that the conveyor belt drives the plurality of second body parts 12 to move synchronously. multi-way valve 90 has a plurality of connection valve ports and a main valve port, and each of the plurality of connection valve ports can be connected and disconnected with the main valve port. The plurality of connection valve ports are connected with and in communication with the first connecting ports 122 of the plurality of second body parts 12 at the plurality of preset positions in a one-to-one correspondence manner, and the main valve port is connected with and in communication with the air suction port of the vacuum unit 200. When the connection valve port corresponding to the first connection port 122 of the second body part 12 at each preset position is in communication with the main valve port, the first connection port 122 of the second body part 12 at the preset position is in communication with the air suction port of the vacuum unit 200, and the evacuation operation can be performed. When the connection valve port corresponding to the first connection port 122 of the second body part 12 at each preset position is disconnected with the main valve port, the first connection port 122 of the second body part 12 at the preset position is disconnected with the air suction port of the vacuum unit 200.

In the specific implementation process, the second body part 12 at the freeze-drying position is connected with and in communication with one connection valve port of the multi-way valve 90, so that the second body part 12 at the freeze-drying position can be in communication with the air suction port of the vacuum unit 200, and then the evacuation operation can be performed on the second cavity 121 of the second body part 12 at the freeze-drying position, so as to ensure that the second cavity 121 is at an appropriate degree of dryness during the spray freezing operation.

As shown in FIG. 1, six preset positions are provided, which are respectively a first preset position 210, a second preset position 220, a third preset position 230, a fourth preset position 240, a fifth preset position 250, and a sixth preset position 260. The first preset position 210 is the freeze-drying position, the second preset position 220 is the downstream vacuumizing position, and the sixth preset position 260 is the upstream vacuumizing position. The multi-way valve 90 is a six-way valve.

In some embodiments, a connection pipeline between the first connection port 122 of the second body part 12 at each preset position and the corresponding connection valve port of the multi-way valve 90 is configured with a third pressure detection component 95, so as to detect the pressure of gas in the connection pipeline between the first connection port 122 of the second body part 12 at each preset position and the corresponding connection valve port of the multi-way valve 90.

In some embodiments, the connection pipeline between the first connection port 122 of the second body part 12 at each preset position and the corresponding connection valve port of the multi-way valve 90 is configured with an eleventh control valve 96, so as to control the connection and disconnection of the connection pipeline between the first connection port 122 of the second body part 12 at each preset position and the corresponding connection valve port of the multi-way valve 90, and control a flow rate of the gas in the connection pipeline between the first connection port 122 of the second body part 12 at each preset position and the corresponding connection valve port of the multi-way valve 90. The corresponding eleventh control valve 96 is in a closed state, so that the second cavity 121 of the second body part 12 at each preset position is vacuum-isolated. In some embodiments, the connection pipeline between the first connection port 122 of the second body part 12 at each preset position and the corresponding connection valve port of the multi-way valve 90 is configured with a humidity detection component, and at least part of each humidity detection component is located in the corresponding connection pipeline, so as to detect the humidity in the corresponding connection pipeline. Alternatively, each second body part 12 is configured with a hygrometer, and at least part of each hygrometer is located in the second cavity 121 of the corresponding second body part 12, so as to detect the humidity in the second cavity 121 of the corresponding second body part 12. In some embodiments, the humidity detection component is a hygrometer.

In some embodiments, the freeze-drying apparatus further includes a cold trap assembly 94. The cold trap assembly 94 includes a cold trap refrigerator 941 and two cold traps 942. The cold trap refrigerator 941 has two cooling medium outlets and two cooling medium inlets, and each cold trap 942 has a cooling medium outlet and a cooling medium inlet. The cooling medium inlets of the two cold traps 942 are connected with and in communication with the two cooling medium outlets of the cold trap refrigerator 941 in a one-to-one correspondence manner, and the cooling medium outlets of the two cold traps 942 are connected with and in communication with the two cooling medium inlets of the cold trap refrigerator 941 in a one-to-one correspondence manner, so as to form two cooling cycles. Each cold trap 942 forms one cooling cycle with the corresponding cooling medium outlet and the corresponding cooling medium inlet of the cold trap refrigerator 941. Each cold trap 942 further has an air inlet and an air outlet. The air inlet of each cold trap 942 is connected with and in communication with the main valve port of the multi-way valve 90, and the air outlet of each cold trap 942 is connected with and in communication with the air suction port of the vacuum unit 200.

The two cold traps 942 are disposed in parallel, and the two cold traps 942 are used alternately, that is, the two cold traps 942 use a double cold trap mode of alternate cooling. When one cold trap 942 is in an evacuated gas passage to trap water vapor, the other cold trap 942 is in an ice-melting pre-cooling state. In the specific implementation process, when the amount of icing in one cold trap 942 reaches a certain degree, the ability of the cold trap 942 to trap the water vapor may be greatly reduced, so that it is necessary to switch the evacuated gas passage to the other pre-cooled cold trap 942 that has not trapped the water vapor. The previously fully loaded cold trap 942 needs to be melted to prepare for the next cold trap switching.

In some embodiments, the cold trap assembly 94 further includes two seventh pipelines 947 and two eighth control valves 948. The two seventh pipelines 947 and the two cold traps 942 are disposed in a one-to-one correspondence manner, so that the air outlet of each cold trap 942 is connected with and in communication with a first pipe port of the corresponding seventh pipeline 947. The freeze-drying apparatus further includes a sixth pipeline 91. Second pipe ports of the two seventh pipelines 947 are connected with and in communication with a first pipe port of the sixth pipeline 91, and a second pipe port of the sixth pipeline 91 is connected with and in communication with the air suction port of the vacuum unit 200. The two eighth control valves 948 are disposed on the two seventh pipelines 947 in a one-to-one correspondence manner, so as to control the connection and disconnection of the corresponding seventh pipeline 947 through each eighth control valve 948. In the specific implementation process, one of the eighth control valves 948 is opened and the other eighth control valve 948 is closed, so that one seventh pipeline 947 is in a connected state and the other seventh pipeline 947 is in a disconnected state, and then one cold trap 942 is in the evacuated gas passage to trap the water vapor and the other cold trap 942 is in the ice-melting pre-cooling state. In some embodiments, the eighth control valve 948 is an electric ball valve.

In some embodiments, a connection pipeline between the cooling medium inlet of each cold trap 942 and the corresponding cooling medium outlet of the cold trap refrigerator 941 is configured with a ninth control valve 943, so as to control the connection and disconnection of the connection pipeline between the cooling medium inlet of each cold trap 942 and the corresponding cooling medium outlet of the cold trap refrigerator 941 through the corresponding ninth control valve 943, and control a flow rate of the medium in the connection pipeline between the cooling medium inlet of each cold trap 942 and the corresponding cooling medium outlet of the cold trap refrigerator 941. In some embodiments, the ninth control valve 943 is a solenoid valve.

In some embodiments, a connection pipeline between the cooling medium outlet of each cold trap 942 and the corresponding cooling medium inlet of the cold trap refrigerator 941 is configured with a tenth control valve 944, so as to control the connection and disconnection of the connection pipeline between the cooling medium outlet of each cold trap 942 and the corresponding cooling medium inlet of the cold trap refrigerator 941 through the corresponding tenth control valve 944, and control the flow rate of the medium in the connection pipeline between the cooling medium outlet of each cold trap 942 and the corresponding cooling medium inlet of the cold trap refrigerator 941. In some embodiments, the tenth control valve 944 is a solenoid valve.

In some embodiments, the cold trap assembly 94 further includes two fourth temperature detection components 945. The two fourth temperature detection components 945 and the two cold traps 942 are disposed in a one-to-one correspondence manner, and at least part of each fourth temperature detection component 945 is disposed in the corresponding cold trap 942, so as to detect the temperature of a cooling cavity wall of the cavity where a cooling medium in the corresponding cold trap 942 is located. In some embodiments, the temperature of the cooling cavity wall of the cavity where the cooling medium in the cold trap 942 is located is reduced to a design temperature, and the design temperature is 10 °C to 15 °C lower than the temperature in the freezing cavity 101.

In some embodiments, the cold trap assembly 94 further includes two second pressure detection components 946. The two second pressure detection components 946 and the plurality of cold traps 942 are disposed in a one-to-one correspondence manner. At least part of each second pressure detection component 946 is disposed in the corresponding cold trap 942, so as to detect the pressure of the gas in a flow channel for gas circulation in the corresponding cold trap 942, and then obtain the vacuum degree in the flow channel.

In some embodiments, the freeze-drying apparatus further includes a control component 500. All electrical components of the freeze-drying apparatus are in communication connection with the control component 500, so that the control component 500 controls all the electrical components.

The freeze-drying apparatus of the present disclosure is used to perform a continuous spray freeze-drying test on a reagent material with a known eutectic point, and a series of process parameters are formulated according to the most economical material spreading thickness, generally 10 mm to 15 mm, and an appropriate flow rate. The specific test process is as follows.
1. Apparatus debugging is performed, that is, before the test, the apparatus is subjected to a sealing performance test and purged with dry nitrogen to ensure the normal operation of the apparatus.
2. Batching is performed, that is, a glycine methyl ester hydrochloride aqueous solution required for the test is prepared as a reagent material.
3. Pre-cooling is performed, that is, the freezing cavity 101 is pre-cooled by using the liquid nitrogen, and temperature control systems of the temperature control component 70 and the two cold traps 942 is opened in advance to prevent the collapse of the frozen reagent particle structure after the liquid nitrogen is closed later, and to avoid the damage to the vacuum unit caused by the cold trap 942 not trapping the water vapor timely.
4. Spray freezing is performed, that is, the nitrogen is sprayed through the nitrogen inlet 24, and the reagent material is sprayed through the reagent inlet 22, the reagent material is atomized by using the sprayed nitrogen and frozen in the low-temperature cavity, and then falls onto the sieve plate 124.

5. Vacuum drying is performed, that is, the second body part 12 containing the frozen material is conveyed to the downstream vacuumizing position by using the conveyor belt, and vacuum drying is performed according to a predetermined drying curve until circulating to the upstream vacuumizing position, the material is unloaded after drying, and preparations are made for the next spray freezing to enter the next cycle, and then the cycle continues. The reagent powder or reagent particles prepared by the freeze-drying apparatus of the present disclosure are evenly spread on the sieve plate 124. The freeze-drying apparatus of the present disclosure can perform a uniform vacuum drying process, and adjust the number of vacuum drying stages according to the time of the drying process of the reagent material itself, i.e., determine the number of vacuumizing positions according to the reagent material itself. The freeze-drying apparatus of the present disclosure truly achieves the continuity, integration and intelligence of the spray freeze-drying process.

From the above description, it can be seen that the above embodiments of the present disclosure achieve the following technical effects.

In the spray freeze-drying device provided by the present disclosure, the spray freeze-drying device includes a freeze-drying component 10 and a reagent nozzle 20. The freeze-drying component 10 includes a first body part 11 and a second body part 12, the first body part 11 has a first cavity 111, and the second body part 12 has a second cavity 121 and a first connection port 122, the first connection port 122 is in communication with the second cavity 121. The first body part 11 is detachably connected with the second body part 12. When the first body part 11 is connected with the second body part 12, the first cavity 111 is in communication with the second cavity 121 so as to jointly form a freezing cavity 101, and the first cavity 111 is located above the second cavity 121. The reagent nozzle 20 has a first nozzle port 21, a reagent inlet 22, a nitrogen inlet 24, and a first channel 23, and the first nozzle port 21, the reagent inlet 22, and the nitrogen inlet 24 are all in communication with the first channel 23. The reagent nozzle 20 penetrates through the first body part 11, so that the first nozzle port 21 is in communication with the first cavity 111. The reagent inlet 22 is configured to introduce a reagent, a preset amount of nitrogen is introduced into the first channel 23 through the nitrogen inlet 24 while the liquid reagent is introduced into the first channel 23 through the reagent inlet 22, so that the liquid reagent entering the first channel 23 is atomized into the liquid droplet reagent under the action of pressure generated by the preset amount of nitrogen. When the liquid droplet reagent is sprayed into the freezing cavity 101 through the first nozzle port 21, reagent ice droplets are formed and then falls into the second cavity 121, thereby completing a spray freezing operation.

When the reagent ice droplets falling into the second cavity 121 reach a set amount, the first body part 11 is detached from the second body part 12, and the first connection port 122 of the second body part 12 carrying the reagent ice droplets is in communication with an air suction port of a vacuum unit 200, so as to evacuate the second cavity 121, thereby performing vacuum drying on the second cavity 121, i.e., performing vacuum drying on the reagent ice droplets in the second cavity 121.

According to the spray freeze-drying device of the present disclosure, the first body part 11 is detachably connected with the second body part 12, so that one second body part 12 can be connected with the first body part 11 so as to perform the spray freezing operation, and another second body part 12 can perform an evacuation operation, thereby improving the reagent preparation efficiency and solving the problem in the related art of relatively low reagent preparation efficiency of a continuous vacuum drying apparatus.

It is to be noted that the terms “first”, “second” and the like in the specification, claims and the above drawings of the present disclosure are used for distinguishing similar objects rather than describing a specific sequence or a precedence order. It should be understood that the data used in such a way can be exchanged where appropriate, in order that the implementations of the present disclosure described here, for example, can be implemented in an order other than those illustrated or described herein. In addition, terms “include” and “have” and any variations thereof are intended to cover non-exclusive inclusions. For example, it is not limited for processes, methods, systems, products or apparatuses containing a series of steps or units to clearly list those steps or units, and other steps or units which are not clearly listed or are inherent to these processes, methods, products or apparatuses can be included instead.

For ease of description, spatially relative terms such as “over”, “above”, “on an upper surface” and “upper” can be used herein for describing a spatial position relation between a device or feature and other devices or features shown in the drawings. It should be understood that the spatially relative terms are intended to contain different orientations of the devices in usage or operation besides the orientations of the devices described in the drawings. For example, if the devices in the drawings are inverted, those described as “above other devices or structures” or “over other devices or structures” will then be positioned as “below other devices or structures” or “under other devices or structures”. Thus, the exemplary term “above” can include both “above” and “below” orientations. The device can also be positioned in various other ways (rotated 90 degrees or at other orientations) and the spatially relative descriptions used herein are interpreted accordingly.

The above are only the preferred embodiments of the present disclosure, and is not intended to limit the present disclosure, and for those skilled in the art, various modifications and changes can be made to the present disclosure. Any modifications, equivalent substitutions, improvements, etc. within the spirit and principle of the present disclosure shall be included in the scope of protection of the present disclosure.

1. A spray freeze-drying device, comprising:
a freeze-drying component, the freeze-drying component comprises a first body part and a second body part, the first body part has a first cavity, and the second body part has a second cavity and a first connection port, the first connection port is in communication with the second cavity; wherein the first body part and the second body part are detachably connected; when the first body part and the second body part are connected, the first cavity is in communication with the second cavity to jointly form a freezing cavity, and the first cavity is located above the second cavity; and
a reagent nozzle, the reagent nozzle has a first nozzle port, a reagent inlet, a nitrogen inlet and a first channel, the first nozzle port, the reagent inlet and the nitrogen inlet are all in communication with the first channel; wherein the reagent nozzle penetrates through the first body part, the first nozzle port is in communication with the first cavity;
wherein while a liquid reagent is introduced into the first channel through the reagent inlet, a preset amount of nitrogen is introduced into the first channel through the nitrogen inlet, the liquid reagent entering the first channel is atomized into liquid droplet reagent under a pressure generated by the preset amount of nitrogen; when the liquid droplet reagent is sprayed into the freezing cavity through the first nozzle port, reagent ice droplets are formed and fall into the second cavity; and
by detaching the second body part from the first body part, the first connection port of the second body part carrying the reagent ice droplets is configured to be in communication with an air suction port of a vacuum unit, to perform vacuum drying on the second cavity.

2. The spray freeze-drying device as claimed in claim 1, wherein an upper end of the second cavity is open, and a lower end of the first cavity is open; when the first body part is connected with the second body part, a lower end port of the first cavity is in communication with an upper end port of the second cavity in a docking manner; and the spray freeze-drying device further comprises:
a sealing cover, the sealing cover is configured to cover the upper end port of the second cavity after the second body part is detached from the first body part.

3. The spray freeze-drying device as claimed in claim 1, wherein the spray freeze-drying device further comprises:
a sieve plate, the sieve plate is disposed in the second cavity, and the sieve plate is spaced apart from a bottom wall of the second cavity, the reagent ice droplets entering the second cavity fall onto the sieve plate.

4. The spray freeze-drying device as claimed in claim 3, wherein the spray freeze-drying device further comprises:
a heat exchange component, the heat exchange component is disposed in the second cavity, and the heat exchange component is located between the sieve plate and the bottom wall of the second cavity; and
a temperature control component, the temperature control component is connected with the heat exchange component to control a temperature of a heat exchange medium in the heat exchange component; wherein when the second body part is connected with the first body part, the heat exchange medium in the heat exchange component is a cooling medium.

5. The spray freeze-drying device as claimed in claim 1, wherein the spray freeze-drying device further comprises:
liquid nitrogen nozzle, the liquid nitrogen nozzle has a second nozzle port, a liquid nitrogen inlet and a second channel, the second nozzle port and the liquid nitrogen inlet are both in communication with the second channel; wherein the liquid nitrogen nozzle penetrates through the first body part, the second nozzle port is in communication with the first cavity.

6. The spray freeze-drying device as claimed in claim 1, wherein the reagent nozzle further has a communication opening, the communication opening is in communication with the first channel, the reagent nozzle has a first end and a second end disposed opposite each other, the first nozzle port is disposed at a second end portion of the reagent nozzle, and the second end of the reagent nozzle penetrates through the first body part; and the communication opening is disposed at a first end portion of the reagent nozzle; the spray freeze-drying device further comprises:
a third pipeline, a first pipe port of the third pipeline is configured to introduce nitrogen, and a second pipe port of the third pipeline is in communication with the communication opening in a docking manner; wherein the third pipeline is configured in a connected and disconnected manner; and
an unclogging part, the unclogging part is disposed at the communication opening, wherein the unclogging part is elastically connected with an inner wall of the first end of the first channel, when nitrogen is introduced into the third pipeline, under an action of a nitrogen gas flow and an elastic force, the unclogging part reciprocates along a distribution direction of the first end and the second end of the reagent nozzle; and when the unclogging part moving towards the first nozzle port, the unclogging part unclogs frozen reagent at the first nozzle port.

7. The spray freeze-drying device as claimed in claim 1, wherein the reagent nozzle has a first end and a second end disposed opposite each other, the first nozzle port is disposed at the second end of the reagent nozzle, and the second end of the reagent nozzle penetrates through the first body part; the spray freeze-drying device further comprises:
a clamping sleeve, the clamping sleeve is sleeved on the second end of the reagent nozzle, the clamping sleeve is located on an outer side of the first body part, and the clamping sleeve contacts the first body part, the reagent nozzle and the first body part are relatively fixed;
wherein the clamping sleeve has a third channel, the third channel is configured to introduce a heating medium, when there is frozen reagent at the first nozzle port, the heating medium introduced into the third channel heats the second end of the reagent nozzle.

8. The spray freeze-drying device as claimed in claim 4, wherein the sieve plate divides the second cavity into an upper cavity part and a lower cavity part, the upper cavity part and the lower cavity part are distributed along a vertical direction, and the upper cavity part is configured to be in communication with the first cavity in a docking manner; the heat exchange component is disposed in the lower cavity part; and the second body part has an exhaust port, the exhaust port is in communication with the lower cavity part.

9. The spray freeze-drying device as claimed in claim 1, wherein the spray freeze-drying device further comprises:
a reagent carrying container, a discharge port of the reagent carrying container is in communication with the reagent inlet; or
a vibrator, the vibrator is disposed on an outer side of the first body part; under a vibration effect of the vibrator, reagent ice droplets attached to an inner wall of the first cavity fall off from the inner wall of the first cavity; or
a reagent carrying container and a vibrator, a discharge port of the reagent carrying container is in communication with the reagent inlet; the vibrator is disposed on an outer side of the first body part; under a vibration effect of the vibrator, reagent ice droplets attached to an inner wall of the first cavity fall off from the inner wall of the first cavity.

10. A freeze-drying apparatus, comprising an annular path, a vacuum unit and the spray freeze-drying device as claimed in claim 1, wherein the spray freeze-drying device has a plurality of second body parts, a plurality of preset positions are disposed at intervals on the annular path, and the plurality of preset positions comprise a freeze-drying position and at least one vacuumizing position;
each of the plurality of second body parts is movably disposed along the annular path, so that each of the plurality of second body parts sequentially passes through the plurality of preset positions;
by stopping movement of the plurality of second body parts, the plurality of second body parts stay at the plurality of preset positions in one-to-one correspondence; the first body part of the spray freeze-drying device is located on a side of the freeze-drying position, and the second body part at the freeze-drying position is connected with the first body part; and the first connection port of the second body part at each of the at least one vacuumizing position is configured to communicate with the air suction port of the vacuum unit.

11. The freeze-drying apparatus as claimed in claim 10, wherein the freeze-drying apparatus further comprises a multi-way valve, the multi-way valve has a plurality of connection valve ports and a main valve port, each of the plurality of connection valve ports is connected with the main valve port in a connected and disconnected manner; and the plurality of connection valve ports are connected with and in communication with the first connection ports of the plurality of second body parts at the plurality of preset positions in one-to-one correspondence, and the main valve port is connected with and in communication with the air suction port of the vacuum unit.

12. The freeze-drying apparatus as claimed in claim 10, wherein the end of the second cavity is open, and a lower end of the first cavity is open; when the first body part is connected with the second body part, a lower end port of the first cavity is in communication with an upper end port of the second cavity in a docking manner; and the spray freeze-drying device further comprises:
a sealing cover, the sealing cover is configured to cover the upper end port of the second cavity after the second body part is detached from the first body part;
two vacuumizing positions adjacent to the freeze-drying position are respectively an upstream vacuumizing position and a downstream vacuumizing position; the sealing cover of the spray freeze-drying device is configured to cover the upper end port of the second cavity of the second body part moving from the freeze-drying position device to the downstream vacuumizing position; and when the second body part moves from the upstream vacuumizing position to the freeze-drying position, the sealing cover is detached from the second body part; the second body part is connected with the first body part at the freeze-drying position.

13. The freeze-drying apparatus as claimed in claim 10; wherein an upper end of the second cavity is open; and a lower end of the first cavity is open; when the first body part is connected with the second body part; a lower end port of the first cavity is in communication with an upper end port of the second cavity in a docking manner; and the spray freeze-drying device further comprises:
a sealing cover; the sealing cover is configured to cover the upper end port of the second cavity after the second body part is detached from the first body part.

14. The freeze-drying apparatus as claimed in claim 10; wherein the spray freeze-drying device further comprises:
a sieve plate; the sieve plate is disposed in the second cavity; and the sieve plate is spaced apart from a bottom wall of the second cavity; the reagent ice droplets entering the second cavity fall onto the sieve plate.

15. The freeze-drying apparatus as claimed in claim 14; wherein the spray freeze-drying device further comprises:
a heat exchange component, the heat exchange component is disposed in the second cavity, and the heat exchange component is located between the sieve plate and the bottom wall of the second cavity; and
a temperature control component, the temperature control component is connected with the heat exchange component to control a temperature of a heat exchange medium in the heat exchange component; wherein when the second body part is connected with the first body part, the heat exchange medium in the heat exchange component is a cooling medium.

16. The freeze-drying apparatus as claimed in claim 10, wherein the spray freeze-drying device further comprises:
liquid nitrogen nozzle, the liquid nitrogen nozzle has a second nozzle port, a liquid nitrogen inlet and a second channel, the second nozzle port and the liquid nitrogen inlet are both in communication with the second channel; wherein the liquid nitrogen nozzle penetrates through the first body part, the second nozzle port is in communication with the first cavity.

17. The freeze-drying apparatus as claimed in claim 10, wherein the reagent nozzle further has a communication opening , the communication opening is in communication with the first channel, the reagent nozzle has a first end and a second end disposed opposite each other, the first nozzle port is disposed at a second end portion of the reagent nozzle, and the second end of the reagent nozzle penetrates through the first body part; and the communication opening is disposed at a first end portion of the reagent nozzle; the spray freeze-drying device further comprises:
a third pipeline, a first pipe port of the third pipeline is configured to introduce nitrogen, and a second pipe port of the third pipeline is in communication with the communication opening in a docking manner; wherein the third pipeline is configured in a connected and disconnected manner; and
an unclogging part, the unclogging part is disposed at the communication opening, wherein the unclogging part is elastically connected with an inner wall of a first end of the first channel, when nitrogen is introduced into the third pipeline, under an action of a nitrogen gas flow and an elastic force, the unclogging part reciprocates along a distribution direction of the first end and the second end of the reagent nozzle; and when the unclogging part moving towards the first nozzle port, the unclogging part unclogs frozen reagent at the first nozzle port.

18. The freeze-drying apparatus as claimed in claim 10, wherein the reagent nozzle has a first end and a second end disposed opposite each other, the first nozzle port is disposed at the second end of the reagent nozzle, and the second end of the reagent nozzle penetrates through the first body part; the spray freeze-drying device further comprises:
a clamping sleeve, the clamping sleeve is sleeved on the second end of the reagent nozzle, the clamping sleeve is located on an outer side of the first body part, and the clamping sleeve contacts the first body part, the reagent nozzle and the first body part are relatively fixed;
wherein the clamping sleeve has a third channel, the third channel is configured to introduce a heating medium, when there is frozen reagent at the first nozzle port, the heating medium introduced into the third channel heats the second end of the reagent nozzle.

19. The freeze-drying apparatus as claimed in claim 15, wherein the sieve plate divides the second cavity into an upper cavity part and a lower cavity part, the upper cavity part and the lower cavity part are distributed along a vertical direction, and the upper cavity part is configured to be in communication with the first cavity in a docking manner; the heat exchange component is disposed in the lower cavity part; and the second body part has an exhaust port, the exhaust port is in communication with the lower cavity part.

20. The freeze-drying apparatus as claimed in claim 10, wherein the spray freeze-drying device further comprises:
a reagent carrying container, a discharge port of the reagent carrying container is in communication with the reagent inlet; or
a vibrator, the vibrator is disposed on an outer side of the first body part; under a vibration effect of the vibrator, reagent ice droplets attached to an inner wall of the first cavity fall off from the inner wall of the first cavity; or
a reagent carrying container and a Vibrator, a discharge port of the reagent carrying container is in communication with the reagent inlet; the vibrator is disposed on an outer side of the first body part; under a Vibration effect of the vibrator, reagent ice droplets attached to an inner wall of the first cavity fall off from the inner wall of the first cavity.
